(19) United States
(12) Patent Application Publication
(10) Pub. No.: US 2004/0213252 A1
(43) Pub. Date: Oct. 28, 2004

(54) ADSL access multiplexer connected to ethernet and ADSL network system using the same

(75) Inventors: Myoungu Lee, Seoul (KR); Cheolho Ji, Seoul (KR)

Correspondence Address: BRUCE E. LILLING, LILLING & LILLING P.C., P.O. BOX 560, GOLDEN BRIDGE, NY, 10526, US

(73) Assignee: Medialincs Co., Ltd.

(21) Appl. No.: 09/860,188

(22) Filed: May 17, 2001

(30) Foreign Application Priority Data
May 15, 2000 (KR) 2000-26350

(51) Int. Cl. H04L 12/28; H04L 12/66; H04J 3/16

(52) U.S. Cl. 370/395.1; 370/463; 370/466

(57) ABSTRACT

Disclosed relates to an asymmetric digital subscriber line (ADSL) access multiplexer connected direct to existing Ethernet and an ADSL network system using the ASDL access multiplexer. The ADSL network system excludes a conventional network access server (NAS) and connects the ADSL access multiplexer direct to the Ethernet, thus decentralizing the processes for authentication, imposition of charge and traffic to a corresponding local network. Accordingly, the problem of traffic centralization raised by the conventional NAS is solved readily. Besides, the ADSL access multiplexer according to the invention further includes a remote authentication dial-in user service (RADIUS) client program, whereby the processes for authentication and imposition of charge are made very easily.

### BACKGROUND OF THE INVENTION

1. Field of the Invention

The present invention relates to an asymmetric digital subscriber line (ADSL) and, more particularly, to an ADSL access multiplexer connected direct to existing Ethernet which can reduce the traffic burden, configure the local area network (LAN), and facilitate the management of subscribers in the LAN. Furthermore, the invention involves an ADSL network system consisting of the ADSL access multiplexer which can decentralize the traffic in a high speed communications network.

2. Description of the Related Art

The rapid growth of the information communications on the Internet has created the need for high-speed, low-cost techniques for transmitting data to and from homes, small businesses, schools and the like. A primary method applied commonly to transmitting and receiving digital data involves the use of telephone modems. A telephone modem is used to transmit digital data generated by a computer to an intended destination over standard telephone lines. This setup enables computers to gain access to the Internet and other on-line services over standard telephone jacks. Although this form of communications is convenient, it is painfully slow because telephone lines simply consist of twisted pair wires that support “plain old telephone service” (POTS). That is, the conventional telephone modem supplies data transmission rates up to 56 kilobits per second (Kbps), which cannot accommodate smoothly multimedia services such as multimedia conference, video on demand (VOD) and the like. Accordingly, a desired method for providing the multimedia services perfectly is to establish an optical fiber cable network up to customer premises. However, to establish the same network to all the customers expected is time-consuming and entails enormous expenses.

Accordingly, an ADSL standard using the conventional twisted pair wires has been developed to provide multimedia services economically. According to the ADSL standard, digital data can be transmitted and received through twisted pair wires for POTS. The digital data is transmitted and received with higher bandwidth than analog frequency bandwidth for telephone services. Consequently, the customer can receive multimedia services at high speed through digital data transmission, as well as common telephone services.

The ADSL standard provides downstream data rates up to 8 Megabits per second (Mbps) from the central office to the customer while providing upstream data rates from the customer premises to the central office up to 640 Kbps. This asymmetric relationship between downstream and upstream data rates matches the original intent of ADSL to provide high bandwidth multimedia services downstream with more limited bandwidth requirements upstream from the customer premises.

FIG. 1 is a block diagram showing an ADSL architecture consisting of a conventional network access server (NAS), which is configured based on asynchronous transfer mode (ATM) network. The conventional ADSL network system in FIG. 1 comprises a customer terminal part 10, a DSL access multiplexer (DSLAM) 20 and a network access server (NAS) 30. The basic ADSL architecture includes an ADSL terminal unit-remote (ATU-R) 12 as an ADSL interface unit at the customer premise, and an ADSL terminal unit-central office (ATU-C) 22 as an ADSL interface at the telephone company central office, which are interconnected by a twisted pair wire 1 for POTS through a customer splitter 11 and a central office splitter 21. The customer terminal part 10 includes a customer splitter 11, ATU-R 12, a customer terminal 13 and a telephone 14. The customer splitter 11 splits the telephone signals transmitted from the twisted pair wire 1 to separate an ADSL signal and a telephone signal for POTS. The ADSL signal is forwarded to ATU-R 12 and the telephone signal for POTS is sent to the telephone 14. Then, the ADSL signal is demodulated into digital data by ATU-R 12 and sent to the customer terminal 13. The digital data of the customer terminal 13 is then modulated through ATU-R 12 and transmitted to a DSL access multiplexer (DSLAM) 20, described hereinafter.

DSLAM 20 in FIG. 1 established between the customer terminal part 10 and a network access server (NAS) 30, described hereinafter, executes collecting and routing of traffic for scores or hundreds of subscribers. The DSLAM 20 includes a central office splitter 21, an ADSL terminal unit-central office (ATU-C) 22, provided as much as the number of subscribers, as an ADSL interface at the customer premise, and a network interface 23 for communicating with a core network 2, such as ATM network. The central office splitter 21 splits the telephone signals transmitted from the twisted pair wire 1 to separate an ADSL signal and a telephone signal for POTS. The telephone signal for POTS is transmitted to public telephone networks, such as the public switched telephone network (PSTN), and the ADSL signal is forwarded to the core network 2 through ATU-C 22 and the network interface 23.

The NAS 30 performs the necessary steps to authenticate dial-in users and authorize their access to the requested system or service, usually by verifying the user ID and password, and to process the traffic according to data transmission. That is, the NAS 30, located between the core network 2 and a router 40, couples the DSLAM 20 to the Internet 3. Further, the NAS 30 is coupled to a plurality of DSLAMs 20 established at corresponding area, not depicted in FIG. 1.

As described above, the base ADSL architecture is configured in a manner that the DSLAM 20 established at the telephone company central office can accommodate two hundred subscribers approximately and has the ATU-C 22 as much as the number of subscribers, which needs high installation costs. Besides, if a user wants to subscribe ADSL service, there must be established the DSLAM 20 at corresponding telephone office. Repeatedly, if a telephone office cannot afford install the expensive DSLAM 20 designed for accommodating two hundred subscribers, users within its jurisdiction cannot use the ADSL service. Moreover, it is inhibitive to install the expensive DSLAMs 20 in every telephone offices, which disturbs the spread of the ADSL service. Furthermore, according to the conventional ADSL architecture, at least one NAS 30 is necessarily installed and one NAS 30 is coupled to a plurality of DSLAMs 20 established in corresponding area. That is, since the NAS 30 should accommodate hundreds to thousands of subscribers connected with the plural DSLAMs 20, the traffic burden to be processed is increased geometrically according to increasing of the number of subscribers, thus deteriorating data transmission rates and quality of service. Additionally, since the authentication and routing processes for the respective subscribers are executed by the NAS 30, the various services such as data communications among the subscribers based on the local network are not provided smoothly. Meanwhile, in consideration of expected rapid spread of the multimedia services such as video on demand (VOD), multimedia conference, local Internet broadcasting and the like, there is raised serious drawbacks in authorizing and imposing charges for hundreds to thousands of subscribers through the NAS 30. Consequently, it is desired to provide a system for authentication and imposition based on the local network instead of the conventional ADSL architecture using the NAS 30, if possible.

### BRIEF SUMMARY OF THE INVENTION

Accordingly, the present invention is directed to an ADSL access multiplexer connected to Ethernet that substantially obviates one or more of the problems due to limitations and disadvantages of the related art.

An object of the present invention is to provide an ADSL access multiplexer connected to Ethernet which can exclude the conventional NAS equipment when configuring the ADSL network system by connecting the ADSL lines direct to existing Ethernet, and prevent the traffic centralization, accordingly.

Another object of the present invention is to provide an ADSL network system which can decentralize the traffic to be processed on the Internet using the same ADSL access multiplexer.

To accomplish an object in accordance with a first aspect of the present invention, there is provided an ADSL access multiplexer which connects a plurality of ADSL lines, through which an ADSL signal having a multi-layer structure including an application layer, a link layer and a physical layer is transmitted, to an Ethernet, through which an Ethernet frame signal including an application layer and an Ethernet layer is transmitted, comprising: an ADSL interface part connected to the ADSL lines; an ADSL signal/ATM cell signal converting part, coupled to the ADSL interface part, for executing signal conversions between the ADSL signal and asynchronous transfer mode (ATM) cell signal; an Ethernet interface part executing connection to the Ethernet and transmission of the Ethernet frame signal; a storing part including a predetermined connection mode support program supporting point-to-point (PPP) connection mode, a predetermined protocol process program for the ATM cell signal, a subscriber information required when connecting communications, and an Internet protocol (IP) pool assigned to a subscriber; and a central processing part, positioned between the ADSL signal/ATM cell signal converting part and the Ethernet interface part, for executing a segmentation process for converting the ATM cell signal into the Ethernet frame signal in upstream channels and a reassembly process for converting the Ethernet frame signal into the ATM cell signal in downstream channels based on the protocol process program stored in the storing part, and for assigning IP to the subscriber when connecting the PPP mode based on the connection mode support program and the IP pool.

To accomplish another object in accordance with the first aspect of the invention, the PPP mode is a PPP over ATM (PPPoA), the storing part further includes an IP table for the routing process, and the central processing part executes the routing process for a subscriber's source/destination IP based on the IP table.

To accomplish another object in accordance with the first aspect of the present invention, the PPP mode is a PPP over Ethernet (PPPoE), an ATM interface part is further included, and the central processing part processes communication protocols between the ATM cell signal transmitted and received through the ATM interface part and the ADSL signal transmitted and received through the ADSL interface part, based on the connection mode support program and the protocol process program.

To accomplish another object in accordance with the first aspect of the present invention, the storing part further includes a predetermined remote authentication dial-in user service (RADIUS) client program for processes of authentication and imposition, and the central processing part connected to a RADIUS server through the Internet transmits the subscriber information including subscriber's ID, password, IP address, port number, log-in time, log-out time and packet amount, based on the RADIUS client program.

To accomplish another object in accordance with a second aspect of the invention, there is provided an ADSL network system comprising in sequence: at least a customer terminal part, connected to Internet in a point-to-point over ATM (PPPoA) mode, for processing an ADSL signal of which an application layer is based on an Internet protocol (IP) and a physical layer is an ADSL layer; at least an ADSL access multiplexer, connected to the customer terminal part and operated in a point-to-point over ATM mode, for executing signal conversions between the ADSL signal and an Ethernet frame signal of which the application layer is based on the IP layer and the physical layer is the Ethernet layer; at least an Ethernet switch, connected to the ADSL access multiplexer, for executing signal switching between the Ethernet frame signal and an external signal, transmitted to and from the Internet through a router, of which the application layer is based on the IP layer and the physical layer is a core network layer; and at least a router, positioned between the Ethernet switch and the Internet, for routing a subscriber's source/destination IP.

To accomplish another object in accordance with the second aspect of the invention, the plural ADSL access multiplexers are coupled to the Ethernet switch, thus configuring a single local network.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a block diagram of a basic ADSL architecture using a conventional NAS;

FIG. 2 is a block diagram illustrating a basic concept of an ADSL access multiplexer in accordance with the present invention;

FIG. 3 is a block diagram of an ADSL access multiplexer in FIG. 2 in accordance with an embodiment of the invention;

FIG. 4 is a block diagram of an ADSL access multiplexer in FIG. 2 in accordance with another embodiment of the invention;

FIG. 5 is a block diagram showing an ADSL network system using the ADSL access multiplexer in FIG. 3 in accordance with a first aspect of the present invention;

FIG. 6 depicts a protocol layer of a digital signal processed in the ADSL network system in FIG. 5;

FIG. 7 is a block diagram showing an ADSL network system using the ADSL access multiplexer in FIG. 3 in accordance with a second aspect of the present invention;

FIG. 8 denotes a protocol layer of a digital signal processed in the ADSL network system in FIG. 7; and

FIG. 9 a block diagram showing a brief configuration of a common RADIUS system for illustrating functions of authentication and imposition by the ADSL access multiplexer in accordance with the present invention.

### DETAILED DESCRIPTION OF THE INVENTION

Reference will now be made in detail to the preferred embodiments of the present invention, examples of which are illustrated in the accompanying drawings.

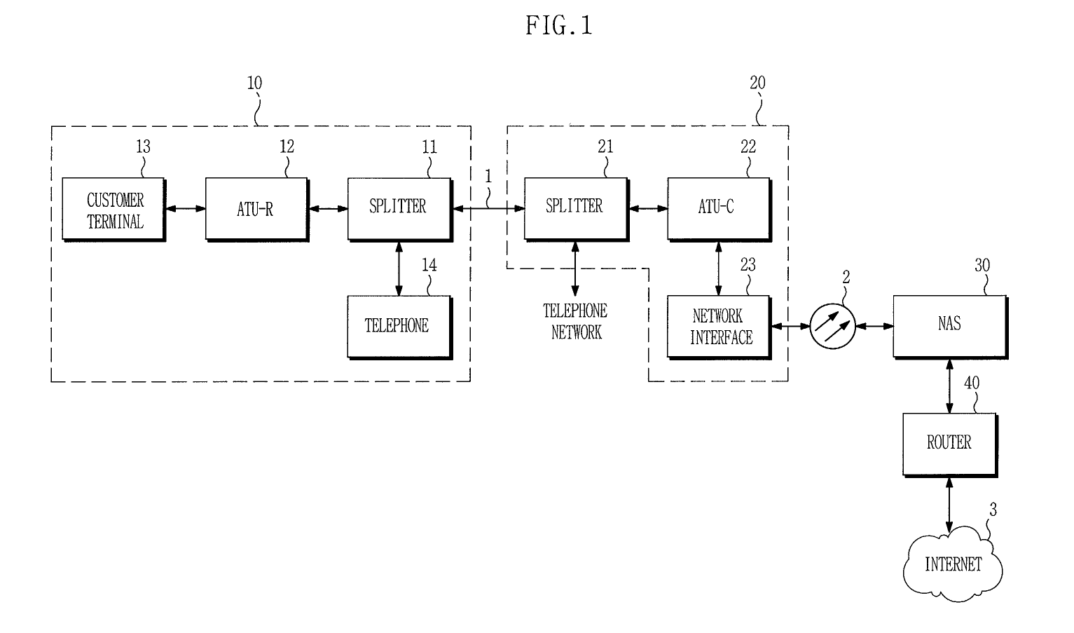

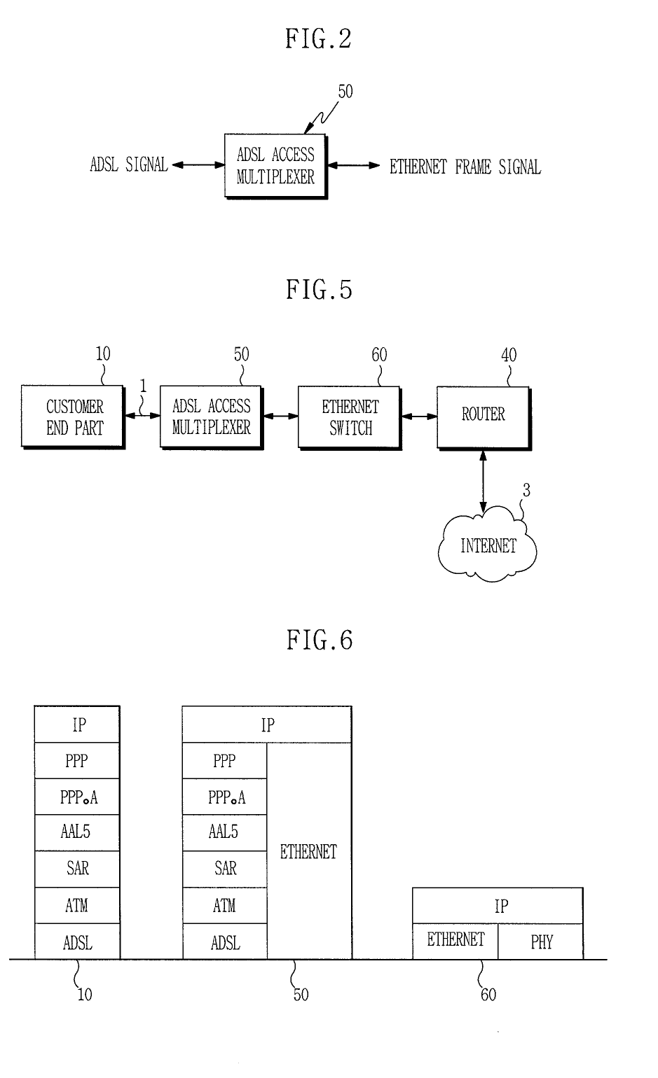

A block diagram illustrating a basic concept of an ADSL access multiplexer in accordance with the invention is shown in FIG. 2. An ADSL access multiplexer 50 for accommodating a small scale of twelve subscribers, for example, converts an ADSL signal transmitted from the customer terminal part 10 in FIG. 1 into an Ethernet frame signal and forwards the converted signal to the outside. Besides, the ADSL access multiplexer converts an Ethernet frame signal input from the outside into an ADSL signal and transmits the converted signal to the customer terminal part 10.

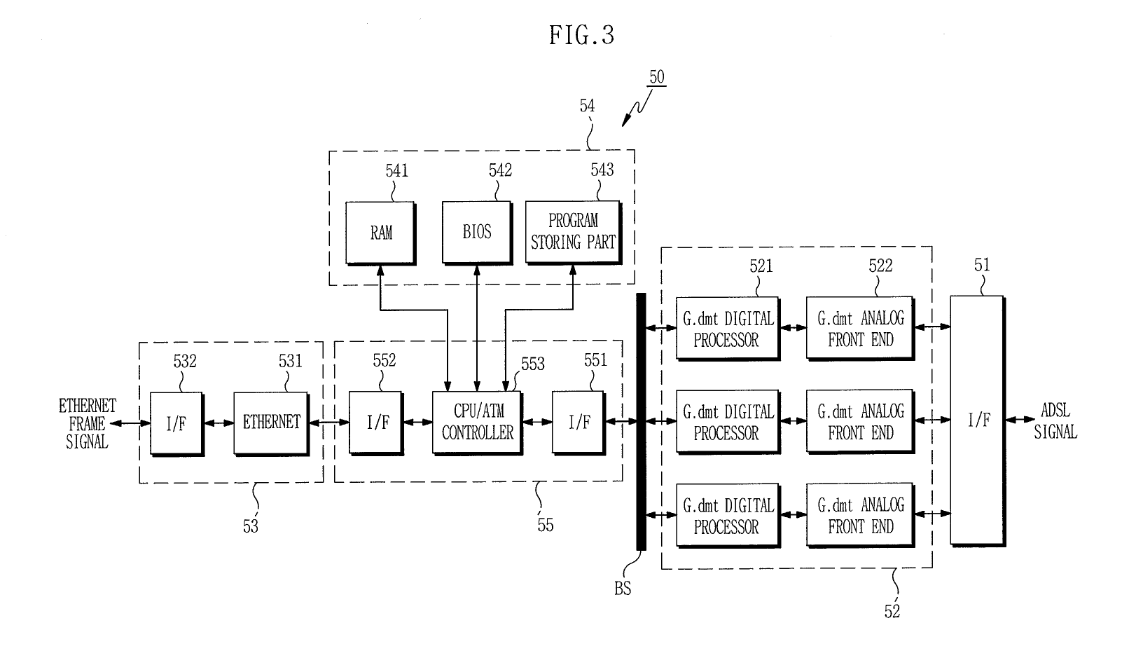

A block diagram showing an internal architecture of the ADSL access multiplexer in accordance with an embodiment of the invention is shown in FIG. 3. The ADSL access multiplexer 50 comprises an ADSL interface part 51, an ADSL signal/ATM cell signal converting part 52, an Ethernet interface part 53, a storing part 54 and a central processing part 55. The ADSL interface part 51 transmits an ADSL signal input from a plurality of twisted pair wires 1, not depicted, to the ADSL signal/ATM cell signal converting part 52, and forwards the ADSL signal encapsulated by the ADSL signal/ATM cell signal converting part 52 to the twisted pair wires 1, vice versa. That is, the ADSL signal/ATM cell signal converting part 52 demodulates the ADSL signal input from the ADSL interface part 51 to decapsulate only the ADSL layer, and modulates the ATM cell signal transmitted from a central processing part 55, described below, to be encapsulated. The ADSL modulation methods is classified into discrete multitone (DMT) and carrierless AM/PM (CAP). DMT that divides a given channel into plural sub-channels and transmits data corresponding to each characteristic of the sub-channels is being widely applied to. The ADSL signal/ATM cell signal converting part 52 includes a plurality of G.dmt analog front ends 522 coupled to the ADSL interface part 51 and a plurality of G.dmt digital processors 521 connected to the G.dmt analog front ends 522 respectively. The G.dmt analog front end 522 is a coder/decoder (CODEC) executing analog-to-digital conversion and digital-to-analog conversion for the ADSL signal. The G.dmt digital processor 521 is a modem for the ADSL modulation and demodulation. The G.dmt, one of the DMT modulation methods, controls the ADSL signal frequency bandwidths and the transmission rates and provides downstream data rates up to 8 Mbps and upstream data rates up to 1 Mbps. The ADSL signal/ATM cell signal converting part 52 is configured in a manner that three G.dmt digital processors 521 is established therein and each G.dmt digital processor 521 accommodates four subscribers, thus processing the ADSL signal modulation/demodulation for twelve subscribers. Besides, it is possible to increase the number of subscribers to be accommodated by adding the G.dmt digital processor 521 and the G.dmt analog front end 522 to the ADSL signal/ATM cell signal converting part 52. The ADSL signal/ATM cell signal converting part 52 is coupled to a central processing part 55 by an ATM bus BS. As well known, the ATM bus BS is controlled by an ATM bus controller, not depicted, and the detailed description will be omitted.

According to the above configuration, the ADSL signal/ATM cell signal converting part 52 is configured to apply the G.dmt modulation method, however, G.lite, one of the DMT modulation methods, can be applied to. The G.lite modulation method provides downstream data rates up to 1.5 Mbps and upstream data rates up to 512 Kbps, which is adapted to an economic ADSL service.

The Ethernet interface part 53 forwards the Ethernet frame signal transmitted from the central processing part 55 to the Ethernet and transmits the Ethernet frame signal input from the Ethernet to the central processing part 55, thus executing connection to the Ethernet and transmission of the Ethernet frame signal. The Ethernet interface part 53 includes a 10/100 Base-T Ethernet socket 531 and a 10/100 Base-T interface 532 intermediating between the 10/100 base-T Ethernet socket 531 and the Ethernet.

The storing part 54 includes a RAM 541, a BIOS 542 and a program storing part 543, which are coupled to a CPU/ATM controller 553 of the central processing part 55, described below. The RAM 541 loads various temporary data generated by the central processing part 55 and driving programs. The BIOS 542 stores various initial data required when booting the system. The program storing part 543 consists of a basic operation program, an IP pool provided when connecting subscribers, an IP table for routing, subscribers' information, such as subscriber's ID, password, and the like, required when connecting subscribers, a connection mode support program for point-to-point mode (PPP), described below, and a protocol process program for converting the ATM cell signal into the Ethernet frame signal (Reassembly) and converting the Ethernet frame signal into the ATM cell signal (Segmentation).

The PPP mode is generally classified into PPP over ATM (PPPoA) mode and PPP over Ethernet (PPPoE) mode. The PPPoA mode is that the PPP layer is raised over the ATM layer, whereby it is possible to decentralize the traffic easily, configure a local network, and interlocks with a virtual private network (VPN) based on the local network and with various intelligent programs. The PPPoE mode is for executing the PPP connection on the Ethernet. The connection mode support program is for the PPPoA mode, especially.

The ADSL access multiplexer 50 in accordance with the present embodiment executes the authentication and routing functions for the subscribers in the PPPoA mode. The connecting mode support program executes routing a subscriber's source/destination IP based on the IP table provided in the program storing part 543. Furthermore, it is possible to configure the connection mode support program that fixes the subscriber's IP according to each port, or endows the subscribers with each private IP, then, supports a network address translation (NAT) function for connecting to an external network with public IPs given. Meanwhile, in case that the IP pool stored in the program storing part 543 or the subscribers' information such as ID, password and the like are updated due to change of network configuration, the updating processes are executed by means of the equipment management system (EMS), as well known. Here, it is desired that a flash memory is applied into the program storing part 543, thus facilitating the registration and update of information. In case that a remote authentication dial-in user service (RADIUS) client program, described below, is provided in the program storing part 543, the registration and update of information is made by means of a RADIUS server.

Meanwhile, it is possible to configure the connection mode support program in the program storing part 543 that supports a bridge mode using the PPPoE mode, as well as the PPPoA mode. Here, since the ADSL access multiplexer 50 of the invention can be coupled to the NAS 30 in FIG. 1 by means of an ATM TO Ethernet switch connecting the ATM network and the Ethernet, it is possible to incorporate the ADSL access multiplexer 50 of the invention in the existing ADSL service network using the NAS 30. In the bridge mode, the ADSL access multiplexer 50 doesn't execute the routing operation, but processes a general bridge function. However, it executes protocol operations of AAL5 and SAR layers, thus connecting the subscriber to the Internet, which will be described in detail below. AAL5 denotes ATM adaptation layer and SAR stands for segmentation and reassembly layer.

Still referring to FIG. 3, the central processing part 55 includes an universal test operation PHY interface for ATM (UTOPIA) interface 551, a peripheral component interface (PCI) 552 and a CPU/ATM controller 553 connected between the interfaces 551 and 552. The UTOPIA interface 441 provides an interface for transmitting and receiving the Ethernet frame signal between the ATM bus BS and the CPU/ATM controller 553. The PCI 552 provides an interface for transmitting the ATM cell signal to and from the Ethernet interface part 53. The CPU/ATM controller 553 controls the overall system and processes ADSL communications connection for subscribers based on the connection mode support program stored in the program storing part 543 of the storing part 54. Besides, the CPU/ATM controller 553 converts the ATM cell signal transmitted by way of the ADSL signal/ATM cell signal converting part 52, the ATM bus BS and the UTOPIA interface 551 into the Ethernet frame signal (Reassembly) and converts the Ethernet frame signal transmitted by way of the Ethernet interface part 53 and the PCI interface 552 into the ATM cell signal (Segmentation) based on the protocol process program.

Hereinafter, the operations of the ADSL access multiplexer 50 configured as shown in FIG. 3 will be described.

First, the signals transmitted from the respective subscribers through the plural twisted pair wires 1 includes an ADSL signal and a telephone signal for POTS. Here, the ADSL signal is input to the ADSL access multiplexer 50 through the ADSL interface part 51 and the separated telephone signal for POTS is transmitted to PSTN through a telephone line, not depicted. The input ADSL signal is DMT-modulated and decapsulated to the ATM cell signal by way of the G.dmt analog front end 552 and the G.dmt digital processor 521 of the ADSL signal/ATM cell signal converting part 52. Subsequently, the central processing part 55 refers the subscriber's ID and password transmitted from the subscriber to the program storing part 543, thus executing the authentication process. Furthermore, the central processing part 55 reassembles the ATM cell signal received by way of the ATM bus 15 BS and the UTOPIA interface 551 to be the Ethernet frame signal and executes the collecting and routing processes for the traffic of the respective subscribers. That is, the ATM cell signal input through the UTOPIA interface 551 is reassembled to be the Ethernet frame signal by the CPU/ATM controller 553 of the storing part 54. In the meantime, data generated from the step of the protocol process of the CPU/ATM controller 553 is stored in the RAM 541. Here, the segmentation process converting the Ethernet frame signal into the ATM cell signal is executed when transmitting data from the Ethernet to the customer premises. Besides, during the protocol process such as reassembly of the ATM cell signal, predetermined application processes related to an application layer are executed by the CPU/ATM controller 553. The application layer denotes an Internet protocol IP, the application processes includes IP assignment, routing and NAT functions in case that the ADSL access multiplexer 50 is set to the PPP mode, for example. The NAT function is for making most use of the insufficient public IPs. In case that the ADSL access multiplexer 50 is set to the bridge mode, the IP administration including the assignment of IP using the IP pool stored in the program storing part 543 is executed based on a dynamic host configuration protocol (DHCP). The Ethernet frame signal reassembled by the CPU/ATM controller 553 of FIG. 3 is transmitted to the Ethernet by way of the PCI interface 552 and the Ethernet interface part 53.

Meanwhile, the processes for modulating the Ethernet frame signal received from the external network into the ADSL signal and transmitting to the subscriber terminal are executed contrary to the processes described above, and the detailed description will be omitted.

According to the preferred embodiment with reference to FIG. 3, the ADSL access multiplexer 50 supports twelve subscribers, i.e., twelve ports basically, however, it is possible to install more ports according to the increase of the subscriber, since the ADSL access multiplexer 50 can be interconnected to each other. Consequently, in case of a densely built-up area, it is possible to accommodate large-scale subscribers, the same with the existing DSLAM, by coupling a plurality of ADSL access multiplexers 50 to the Ethernet switch.

Besides, the ADSL services including VOD service using the ADSL access multiplexer 50 in FIG. 3 based on the local network can be provided by adding a predetermined RADIUS client program, for executing the processes of authentication for the subscribers and imposition for the provided services, to the program storing part 543. As well known, the RADIUS is a client/server protocol and software that enables the customer terminal part 10 in FIG. 1 to communicate with a central RADIUS server, not depicted, to authenticate dial-in users and authorize their access to the requested system or service, and the detailed description will be followed.

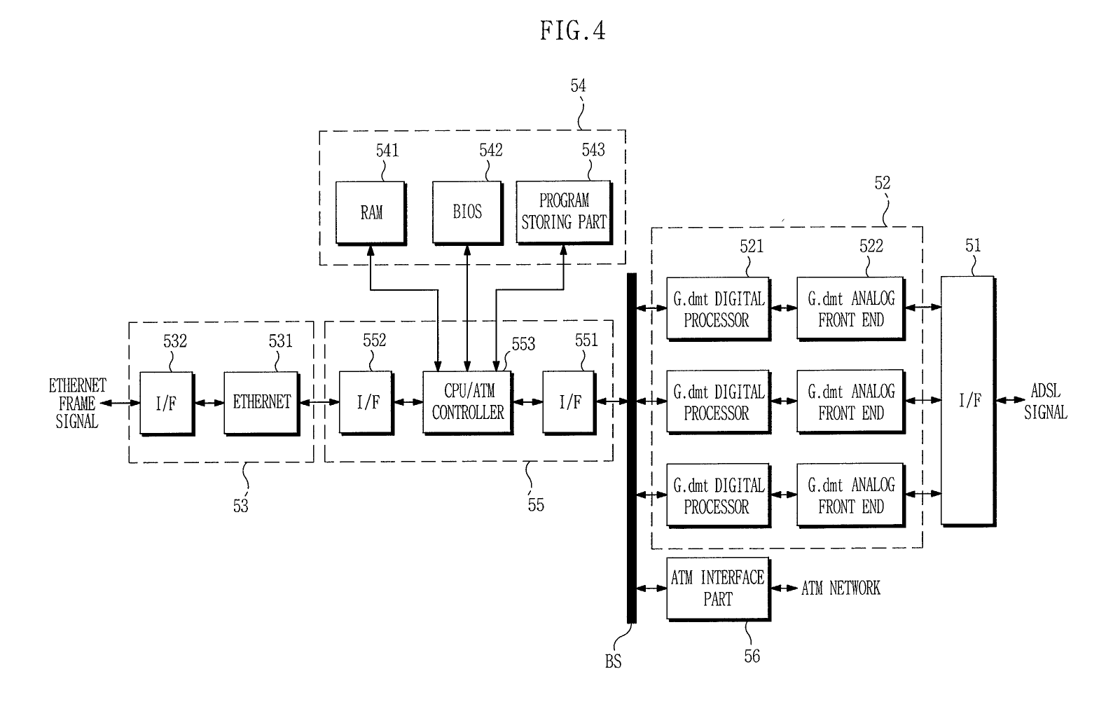

Now referring to FIG. 4 showing a block diagram of an ADSL access multiplexer 50 in FIG. 2 in accordance with another embodiment of the invention, identical components with reference to FIG. 3 are indicated by identical reference numerals, and the detailed description will be omitted.

An additional ATM interface part 56 is provided, attached to the ATM bus BS, for coupling to an external ATM network. The ATM interface part 56 supports the ATM25 interface, for example. Accordingly, it is possible to connect to the NAS 30 in FIG. 1 through the ATM network coupled to the ATM interface part 56.

The program storing part 571 further includes a predetermined protocol process program for processing protocols between the ATM cell signal passed through the ATM interface part 56 and the ADSL signal transmitted by way of the ADSL signal/ATM cell signal converting part 52, and a connection mode support program for supporting the PPPoE connection in addition to the program storing part 543 in FIG. 3. According to the configuration described above, it is possible to incorporate the ADSL access multiplexer 50 of the invention in the existing ADSL service network using the NAS 30.

A block diagram of an ADSL network system using the ADSL access multiplexer in FIG. 3 in accordance with an embodiment of invention is shown in FIG. 5, identical components with reference to FIG. 1 are indicated by identical reference numerals, and the detailed description will be omitted.

The ADSL network system comprises a customer terminal part 10, an ADSL access multiplexer 50, an Ethernet switch 60 and a router 40, wherein the ADSL access multiplexer 50 is operated in the PPPoA mode.

Though the respective elements in FIG. 5 are depicted by ones, at least one customer terminal part 10 is connected to the ADSL access multiplexer 50, and at least one ADSL access multiplexer 50 is coupled to the Ethernet switch 60 in practice, thus configuring the ADSL network system in accordance with the invention. The one ADSL access multiplexer 50 accommodating a small scale of twelve subscriber, for example, converts the ADSL signal transmitted from the customer terminal part 10 into the Ethernet frame signal and transmits it to the Ethernet switch 60. Besides, a plurality of ADSL access multiplexers 50 are linked to the Ethernet switch 60 so as to configure a single network, and a plurality of customer terminal parts 10 connected to the ADSL access multiplexer 50 are interconnected to each other, thus connecting and disconnecting the communications. The Ethernet switch 60 coupling an Ethernet to another Ethernet applies a general Ethernet switch executing the function of switching.

That is, the object of the ADSL network system in FIG. 5 is to solve the problems of the traffic centralization and the core network configuration commonly raised with reference to the conventional NAS 30 by excluding the NAS 30 in FIG. 1 and decentralizing the authentication and traffic processes to the core network.

Referring to FIG. 6, a protocol layer of a digital signal processed in the ADSL network system in FIG. 5 will be described hereinafter.

First, major protocols will be described in brief for explaining the preferred embodiment of the invention: IP stands for the Internet protocol by which data is sent from one computer to another on the Internet; PPP is a protocol for communication between two computers using a serial interface; AAL5 denoting an ATM adaptation layer is a connection-oriented protocol having variable transmission rates for providing various services using a lower grade of ATM cell stream; SAR standing for segmentation and reassembly layer executes the segmentation process for dividing data of IP layer, an upper layer, into ATM cell information field of ATM layer, a lower layer, in a predetermined size, and the reassembly process for reassembling the ATM cell information field to be the IP layer data of upper layer; and ADSL defines a physical layer for transmitting data.

The customer terminal part 10 is connected to the ADSL access multiplexer 50 in PPPoA mode, whereby the transmitted ADSL signal has a multi-layer structure of IP, PPP, PPPoA, AAL5, SAR, ATM and ADSL downwardly. Here, the data-link layer is based on the ATM layer and the physical layer is the ADSL layer. When the ADSL signal having such the multi-layer structure in FIG. 6 is transmitted through the twisted pair wire 1 to the ADSL access multiplexer 50 in FIG. 5, all layers other than the IP layer are converted into the Ethernet layer and transmitted to the Ethernet switch 60 as the Ethernet frame signal. Here, the CPU/ATM controller 553 of the ADSL access multiplexer 50 in FIG. 3 processes protocols related to lower layers as well as the IP layer, the application layer, and executes various application processes, such as IP assignment for the respective subscribers, routing, NAT and the like, as the process for the IP layer.

The Ethernet switch 60 in FIG. 6 converts all layers of the Ethernet frame signal input from the ADSL access multiplexer 50 into the physical layer (PHY), excepting the IP layer, and transmits to the Internet through the router 40 in FIG. 5. Here, the physical layer (PHY) applies one of the core networks, such as STM-1, DS3, E1, T1 and the like. According to the ADSL network system in FIG. 5, it is possible to provide high speed Internet services, excluding the NAS 30 in FIG. 1. Besides, if a separate local server, not depicted, is coupled to the Ethernet switch 60 in FIG. 5, it is possible to provide various multimedia services, such as the local Internet broadcasting, VOD service, and the like based on the core network to the respective subscribers, without any traffic burdens.

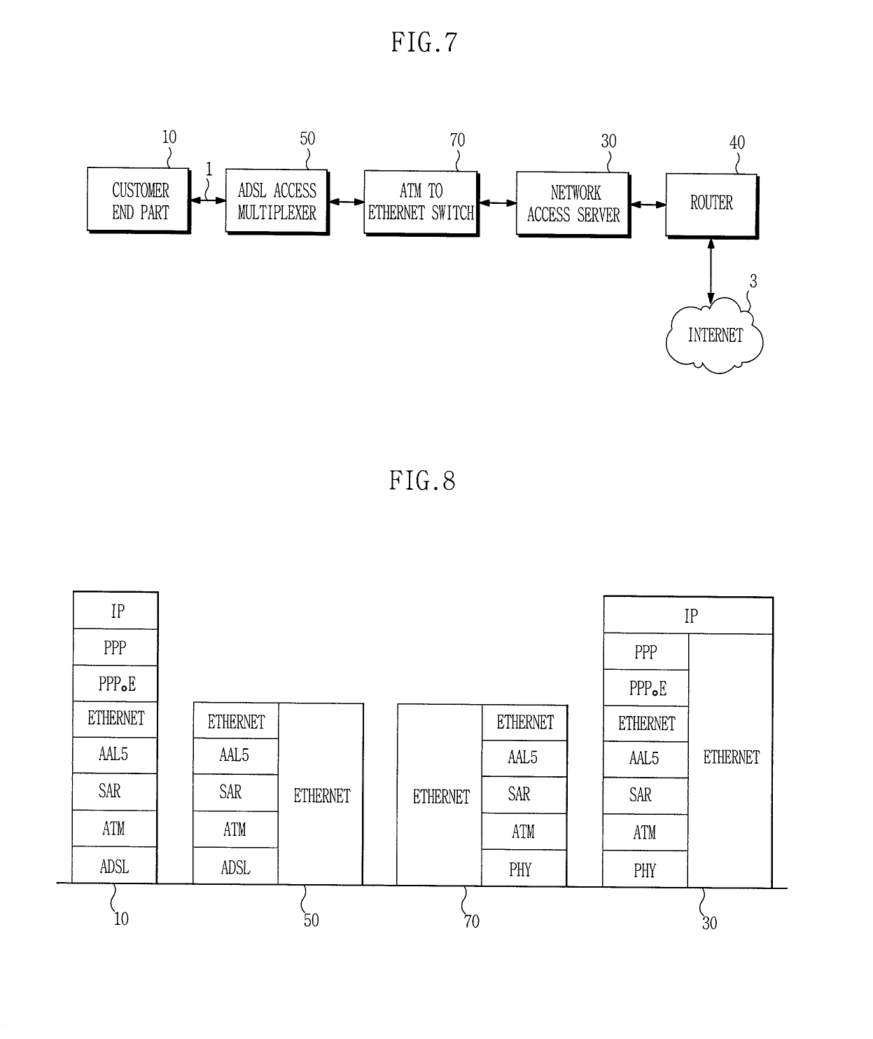

A block diagram of an ADSL network system using the ADSL access multiplexer in FIG. 3 in accordance with another embodiment of the invention is shown in FIG. 7, identical components with reference to FIG. 1 are indicated by identical reference numerals, and the detailed description will be omitted.

The ADSL network system in FIG. 7 comprises a customer terminal part 10, an ADSL access multiplexer 50, an ATM TO Ethernet switch 70, a NAS 30 and a router 40, wherein the ADSL access multiplexer 50 is operated in the bridge mode using PPPoE. The ATM TO Ethernet switch 70 transmits the Ethernet frame signal through the ATM network, such as STM-1 for example. The ATM TO Ethernet switch 70 for coupling the Ethernet to the ATM line is obvious to the skilled in the art, and the detail description will be omitted. In FIG. 7, though one ADSL access multiplexer 50 is coupled to the NAS 30, a plurality of ADSL access multiplexers 50 are coupled to the NAS 30 through the ATM TO Ethernet switch 70 in practice. Accordingly, a plurality of customer terminal parts 10 are connected to the NAS 30 through the corresponding ADSL access multiplexer 50.

According to the configuration described above, since a permanent virtual circuit (PVC) connection, for example, is made between the ATM TO Ethernet switch 70 and the NAS 30 to the dial-in subscriber, the number of PVC required is decreased remarkably as compared with the conventional ADSL network system, thus simplifying the network configuration. The PVC is a software-defined logical connection in a network, which defines logical connections and required bandwidth between end points and manages the traffic. That is, according to the conventional ADSL network system, the PVC connection is achieved between the customer terminal part 10 and the NAS 30, and the NAS 30 should authenticate all the dial-in subscribers and authorize their access to the requested system or service, and make the PVC connection as much as the number of dial-in subscribers, thus complicating the system.

Accordingly, the ADSL network system according to the present invention is disclosed to overcome these drawbacks.

Now referring to FIG. 8, a protocol layer of a digital signal processed in the ADSL network system in FIG. 7 will be described hereinafter.

The ADSL signal processed by the customer terminal part 10 in FIG. 8 has a multi-layer structure of IP, PPP, PPPoE, Ethernet, AAL5, SAR, ATM and ADSL downwardly. When the ADSL signal having such the multi-layer structure is transmitted through the twisted pair wire 1 to the ADSL access multiplexer 50 in FIG. 7, all layers other than the IP, PPP and PPPoE layers are converted into the Ethernet layer and transmitted to the ATM TO Ethernet switch 70 as the Ethernet frame signal. The ATM TO Ethernet switch 70 for intermediating the conversion between the Ethernet frame signal and the ATM cell signal converts the Ethernet layer of the input Ethernet frame signal into the Ethernet, AAL5, SAR, ATM and PHY layers and transmits the converted signal to the NAS 30. Then, the NAS 30 converts all layers other than the IP layer of the input signal into the Ethernet layer and forwards the converted signal to the Internet 3 through the router 40 in FIG. 7. Accordingly, the multi-layer structure described above makes the ADSL access multiplexer 50 to be operated in the bridge mode, thus connecting the ADSL access multiplexer 50 of the invention readily to the NAS 30 comprising the conventional ADSL service network. Besides, it is possible even for the small scale of subscribers to connect the conventional ADSL service network inexpensively. Furthermore, it is possible to configure the network most efficiently since the PVC connection is made only between the ATM TO Ethernet switch 60 and the NAS 30.

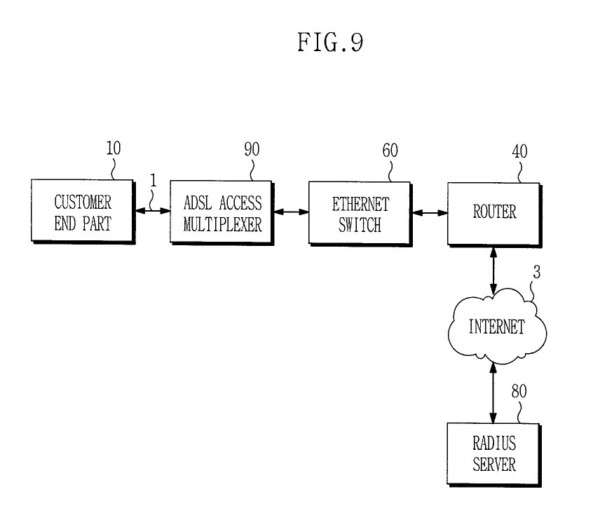

Lastly referring to FIG. 9, a block diagram showing a brief configuration of a RADIUS system using the ADSL access multiplexer 50 of the invention, the functions of authentication and imposition will be described.

A RADIUS system of FIG. 9 comprises a customer terminal part 10, an ADSL access multiplexer 90, an Ethernet switch 60, a router 40 and a RADIUS server coupled to the router 40 through the Internet 3. The ADSL access multiplexer 90 is configured by establishing a predetermined RADIUS client program in addition to the ADSL access multiplexer 50 in FIG. 3. The RADIUS client program transmits a predetermined subscriber information to the RADIUS server 80 in order to authenticate dial-in users and impose charges. The subscriber information includes subscriber's ID, password, IP address, port number, log-in time, log-out time, packet amount and the like. According to the RADIUS system in FIG. 9, the traffic can be decentralized to the respective local networks, thus accomplishing a stable system for the authentication and imposition.

Therefore, according to the present invention, there is provided an ADSL access multiplexer connected to Ethernet which can exclude the conventional NAS equipment when configuring the ADSL network system by connecting the ADSL lines direct to existing Ethernet, and prevent the traffic centralization.

Furthermore, according to the present invention, there is provide an ADSL access multiplexer connected to Ethernet which can facilitate the management of subscriber, such as the authentication and the imposition, for various multimedia services.

Moreover, according to the present invention, there is provide an ADSL network system using the ADSL access multiplexer which can provide various multimedia services, such as video on demand (VOD), multimedia conference, local Internet broadcasting, and the like based on the local network more stably.

It will be apparent to those skilled in the art that various modifications and variations can be made in the ADSL access multiplexer and the ADSL network system using the same of the present invention without departing from the spirit or scope of the invention. Thus, it is intended that the present invention cover the modifications and variations of this invention provided they come within the scope of the appended claims and their equivalents.

1. An asymmetric digital subscriber line (ADSL) access multiplexer for connecting a plurality of ADSL lines, through which an ADSL signal having a multi-layer structure including an application layer, a link layer and a physical layer is transmitted, to an Ethernet, through which an Ethernet frame signal including an application layer and an Ethernet layer is transmitted, comprising:
an ADSL interface part connected to said ADSL lines;
an ADSL signal/ATM cell signal converting part, coupled to said ADSL interface part, for executing signal conversions between said ADSL signal and asynchronous transfer mode (ATM) cell signal;
an Ethernet interface part executing connection to said Ethernet and transmission of said Ethernet frame signal;
a storing part including a predetermined connection mode support program supporting point-to-point (PPP) connection mode, a predetermined protocol process program for said ATM cell signal, a subscriber information required when connecting communications, and an Internet protocol (IP) pool assigned to a subscriber; and
a central processing part, positioned between said ADSL signal/ATM cell signal converting part and said Ethernet interface part, for executing a segmentation process for converting said ATM cell signal into said Ethernet frame signal in upstream channels and a reassembly process for converting said Ethernet frame signal into said ATM cell signal in downstream channels based on said protocol process program stored in said storing part, and for assigning IP to said subscriber when connecting said PPP mode based on said connection mode support program and said IP pool.

2. The ADSL access multiplexer as recited in claim 1, wherein said ADSL signal/ATM cell signal converting part demodulates the ADSL signal input from said ADSL interface part to decapsulate an ADSL layer, transmits the decapsulated ADSL signal to said central processing part through an internal ATM bus, and modulates the ATM cell signal transmitted from said central processing part through said ATM bus to be encapsulated and forwards the encapsulated ATM cell signal to said ADSL interface part.

3. The ADSL access multiplexer as recited in claim 1, wherein said ADSL signal/ATM cell signal converting part includes a coder/decoder (CODEC) executing processes of analog-to-digital conversion and digital-to-analog conversion for the ADSL signal, and a modem executing processes of modulation and demodulation for the ADSL signal.

4. The ADSL access multiplexer as recited in claim 1, wherein said storing part includes a random access memory (RAM) for loading temporary data generated by said central processing part and driving programs, a basic input/output system (BIOS) for storing initial data required when booting said ADSL access multiplexer, and a program storing part having a basic operating system, subscriber information including subscriber's ID and password required when connecting the PPP mode, an IP pool assigned to the subscriber, said connection mode support program and said protocol process program.

5. The ADSL access multiplexer as recited in claim 1, wherein said PPP mode is PPP over ATM (PPPoA); and
wherein said connection mode support program executes a process of authentication for the subscriber based on said subscriber information.

6. The ADSL access multiplexer as recited in claim 1, wherein said PPP mode is PPP over ATM (PPPoA);
wherein said storing part further includes an IP table for the routing process; and
wherein said central processing part executes said routing process for a subscriber's source/destination IP based on said IP table.

7. The ADSL access multiplexer as recited in claim 1, wherein said central processing part includes an universal test operation PHY interface for ATM (UTOPIA) interface, a peripheral component (PCI) interface, and a CPU/ATM controller located between said UTOPIA interface and said PCI interface and driven based on said protocol process program and said connection mode support program stored in said storing part,
wherein said UTOPIA interface provides an interface for transmitting and receiving the ATM cell signal between said ATM bus and said CPU/ATM controller; and
wherein said PCI interface provides an interface for transmitting and receiving the Ethernet frame signal between said Ethernet interface part and said CPU/ATM controller.

8. The ADSL access multiplexer as recited in claim 1, wherein said PPP mode is PPP over Ethernet (PPPoE);
wherein an ATM interface part is further included; and
wherein said central processing part processes communication protocols between the ATM cell signal transmitted and received through said ATM interface part and the ADSL signal transmitted and received through said ADSL interface part, based on said connection mode support program and said protocol process program.

9. The ADSL access multiplexer as recited in claim 1, wherein said link layer of said ADSL signal includes a PPP layer, a PPP over ATM (PPPOA) layer, an ATM adaptation (AAL5) layer, a segmentation and reassembly (SAR) layer, and an ATM layer downwardly;
wherein said physical layer is an ADSL layer;
wherein said ATM cell signal includes the application layer, the PPP layer, the PPPoA layer, the AAL5 layer, the SAR layer and the ATM layer downwardly; and
wherein said application layer is the IP layer.

10. The ADSL access multiplexer as recited in claim 1, wherein said storing part further includes a predetermined remote authentication dial-in user service (RADIUS) client program for processes of authentication and imposition; and
wherein said central processing part connected to a RADIUS server through the Internet transmits said subscriber information including subscriber's ID, password, IP address, port number, log-in time, log-out time and packet amount, based on said RADIUS client program.

11. Asymmetric digital subscriber line (ADSL) network system comprising in sequence:
at least a customer terminal part, connected to Internet in a point-to-point over ATM (PPPoA) mode, for processing an ADSL signal of which an application layer is based on an Internet protocol (IP) and a physical layer is an ADSL layer;
at least an ADSL access multiplexer, connected to said customer terminal part and operated in a point-to-point over ATM mode, for executing signal conversions between said ADSL signal and an Ethernet frame signal of which the application layer is based on the IP layer and the physical layer is the Ethernet layer;
at least an Ethernet switch, connected to said ADSL access multiplexer, for executing signal switching between said Ethernet frame signal and an external signal, transmitted to and from the Internet through a router, of which the application layer is based on the IP layer and the physical layer is a core network layer; and
at least a router, positioned between said Ethernet switch and the Internet, for routing a subscriber's source/destination IP.

12. The ADSL network system as recited in claim 12, wherein said plural ADSL access multiplexers are coupled to said Ethernet switch, thus configuring a single local network.
